(19) United States
(12) Patent Application Publication
(10) Pub. No.: US 2015/0036021 A1
(43) Pub. Date: Feb. 5, 2015

(54) Multiple Scattering Medium For Compressive Imaging

(71) Applicants: Sylvain Gigan, Paris (FR); Geoffroy Lerosey, Paris (FR); Laurent Daudet, Paris (FR); Gilles Chardon, Illkirch (FR); Sebastien Popoff, Montrouge (FR); Igor Carron, Paris (FR)

(72) Inventors: Sylvain Gigan, Paris (FR); Geoffroy Lerosey, Paris (FR); Laurent Daudet, Paris (FR); Gilles Chardon, Illkirch (FR); Sebastien Popoff, Montrouge (FR); Igor Carron, Paris (FR)

(73) Assignees: Centre National De La Recherche Scientifique - CNRS, Paris Cedex 16 (FR); The Texas A&M University System, College Station, TX (US); Universite Pierre Et Marie Curie, Paris (FR)

(21) Appl. No.: 14/354,906

(22) PCT Filed: Nov. 10, 2011
(86) PCT No.: PCT/IB2011/003352

§ 371 Date: Sep. 10, 2014

(51) Int. Cl. H04N 5/335; H04N 5/225; G02B 5/02; H04N 3/02

(52) U.S. Cl. CPC H04N 5/335; H04N 3/02; H04N 5/2254; G02B 5/0273
USPC 348/231.6

(57) ABSTRACT

A method for estimating an optical, electromagnetic or acoustic image having at least the successive steps of: scattering an incident optical, electromagnetic or acoustic signal using a multiple scattering medium corresponding to a known transmission matrix stored into a memory of an imaging system; measuring the scattered signal using a detector array and storing the measurements into the memory of the imaging system; and determining an estimated image having a number of image elements that is greater than the number of measurements, at full spatial bandwidth. The estimated image is determined from the measurements and the transmission matrix using a sparsity-promoting algorithm.

### FIELD OF THE INVENTION

The instant invention relates to systems and methods for estimating optical, electromagnetic or acoustic images using less than one measurement per estimated signal value of the estimated image.

### BACKGROUND OF THE INVENTION

Imaging and visualization devices are typically constituted of an optical assembly of lenses and/or mirrors followed by an array of detectors. The number of elements of this array is traditionally related to the resolution of the acquired image and thus should be as large as possible in most applications.

Nevertheless, a large array of detectors can have two major shortcomings. First, the cost and complexity of each detector can be quite high, especially when it comes to imaging wavelengths of electromagnetic radiation that lies outside the scope of CCD or CMOS detectors. In some cases, the usage of many detectors is actually impossible or impractical. Second, the huge amount of raw data generated by a large detector array can require immediate compression in order to transmit or store data. This compression is computationally demanding while it can be difficult to provide computational resources inside the limited size of an imaging device.

In the past years, a new theory has emerged, known as Compressive Sensing or Compressed Sampling (CS), which could help overcome these limitations. CS theory gives ways to acquire directly a compressed digital representation of a signal without first sampling this signal at Nyquist rate. This means that an image having N pixel at its full resolution can be estimated from the acquisition of K<N measurements, under some sparsity assumptions that in practice is verified by many natural images. Compressive Sensing is a paradigm shift in signal acquisition, the traditional compression procedure being typically “sample, process, keep the important information, and throw away the rest”. See Candès, E., Romberg, J., Tao, T., “Robust uncertainty principles: Exact signal reconstruction from highly incomplete frequency information,” IEEE Trans. Inform. Theory 52 (2006) 489-509; David Donoho, “Compressed sensing,” IEEE Transactions on Information Theory, Volume 52, Issue 4, April 2006, Pages: 1289-1306; and Candès, E., Tao, T., “Near optimal signal recovery from random projections and universal encoding strategies,” (2004) Preprint.

US 2011/0025870 already describes such a method for acquiring images and video using fewer measurements than traditional techniques. In this document, an active optical modulator, that can be for example a digital micromirror device (DMD), a Liquid Crystal Device (LCD) or an array of physically moving shutters, is used to spatially modulate an incident image with a series of pseudorandom patterns. A single or a small number of sensors integrate in time domain the modulated images in order to give a series of inner products between the incident image and the series of random patterns. Eventually, a reconstruction algorithm is used to estimate the incident image from the measurements with the benefit that the estimated image typically comprises more pixels than the number of inner products.

However, this process has a number of shortcomings that call for an improved method. The use of an active optical modulator has major drawbacks. It consumes power and is often expensive, complex and brittle. The acquisition of a series of measurements also slows down the process as it requires time-multiplexing. Furthermore, the complexity of the detection system, more specifically its number of pixels, has not in fact disappeared but was simply translated to a complexity of the optical modulator. In particular, a high resolution image would still need a high resolution optical modulator that can have the drawbacks detailed above. Eventually, the size of the system, having a DMD as the optical modulator, can be quite difficult to reduce given the need to reflect the incident image on the DMD.

The instant invention has notably for object to mitigate those drawbacks. It is the object of the invention to provide a simplified, cost-effective, reliable and low power consumption solution to the problem of estimating an image using the smallest possible number of measurements and in particular less than one measurement per estimated signal value of the estimated image.

### SUMMARY OF THE INVENTION

To this aim, according to the invention, such a method for estimating an optical, electromagnetic or acoustic image comprises an imaging operation having at least the successive steps of:

scattering an incident signal into a scattered signal using a multiple scattering medium characterized by a transmission matrix stored into a memory of an imaging system;

measuring the scattered signal using a detector array to provide measurements and storing the measurements into the memory of the imaging system; and

determining an estimated image comprising a set of image elements from said measurements and said transmission matrix, by means of a processor of said imaging system.

Advantageously, the estimated image has a number of image elements that is greater than the number of measurements.

In some embodiments, one might also use one or more of the following features:
the step of scattering is accomplished by making the incident signal penetrate into the multiple scattering medium;
the step of determining an estimated image uses a sparsity-promoting algorithm.

Advantageously, the method further comprises a characterization operation before the imaging operation, said characterization operation comprising at least successive the steps of:
generating a series of incident waves;
modulating at least some portion of the wavefront of the series of incident waves by a series of patterns using a modulator to provide a series of modulated waves;
scattering the series of modulated waves into a series of scattered waves using the multiple scattering medium;
measuring the series of scattered waves using a detector array to provide a series of measurements;
determining the transmission matrix of the multiple scattering medium from the series of measurements, by means of a processor of the imaging system; and
storing said transmission matrix in a memory of the imaging system.

The present invention also has for object a method for measuring the transmission matrix of a multiple scattering medium, the method comprising the steps of:
generating a series of waves;
modulating at least some portion of the wavefront of the series of incident waves by a series of patterns using a modulator to provide a series of modulated waves;
scattering the series of modulated waves using the multiple scattering medium to provide a series of scattered waves;
measuring the series of scattered waves using a detector array to provide a series of measurements; and
determining the transmission matrix of the multiple scattering medium from the series of measurements, by means of a processor.

Another aspect of the invention is an imaging system for estimating an optical, electromagnetic or acoustic image comprising:
a multiple scattering medium that scatters an incident signal;
a detector array that measures the scattered signal;
a memory that stores a known transmission matrix characterizing the multiple scattering medium; and
a processor that determines an estimated image from the measurements and the transmission matrix. Advantageously, the estimated image has a number of image elements that is greater than the number of measurements.

In some embodiments, one might also use one or more of the following features:
the incident signal penetrates into the multiple scattering medium;
the multiple scattering medium is an object having at least two faces and is arranged in the imaging system so that the incident signal enters the multiple scattering medium through one face and leaves through another face;
the multiple scattering medium is a diffusive material; and
the multiple scattering medium is an amorphous material.

The imaging system might further comprise lenses to focus the incident signal onto the multiple scattering medium and onto the detector array.

### BRIEF DESCRIPTION OF THE DRAWINGS

Other characteristics and advantages of the invention will readily appear from the following description of one of its embodiments, provided as a non-limitative example, and of the accompanying drawings.

On the drawings:

FIG. 1a is a schematic of an apparatus used to measure the transmission matrix of a multiple scattering medium.

FIG. 1b is a schematic of the spatial light modulator.

FIG. 1c is a flow diagram showing how a system in accordance with a preferred embodiment of the present invention measures the transmission matrix of a scattering medium.

FIG. 2 is a singular value decomposition of the transmission matrix of a multiple scattering medium.

FIG. 3 is a flow diagram showing how a system in accordance with a preferred embodiment of the present invention determines an estimated image.

FIG. 4 shows a compressive imaging device in accordance with a preferred embodiment of the present invention.

On the different Figures, the same reference signs designate like or similar elements.

### DETAILED DESCRIPTION

### 1. Compressed Sensing

The Compressed Sensing theory intends to characterize a signal with fewer measurements than by the standard Shannon-Nyquist regular sampling theory. A defining characteristic of Compressive Sensing is that less than one measurement is needed per estimated signal value; a N-sample image can be reconstructed at full spatial bandwidth from M<N measurements. In the following, the expression “element of information” is used as a generic expression for “samples”, “pixels at full resolution” or “elements of images”.

The possibility to recover signal from incomplete information comes from the uses of sparsity or compressibility of an image model. Most commonly acquired images do not consist in random sets of data but rather in organized ones, meaning that there exists some basis, frame or dictionary in which these images have a concise representation. The mathematical equivalent to this concise representation consists in saying that the image or signal x can be represented, in some basis Ψ={Ψ₁, . . . , Ψ_{N}} under the form of a K-sparse matrix, being populated primarily with zeros and having a small number K of non-null coefficients.

$$x \approx {\sum }_{i = 1}^{K} {c}_{{n}_{i}} {ψ}_{{n}_{i}}$$

Here above, nᵢ are vector indices pointing to elements of the basis and cᵢ are non-zero vector coefficients. The “≈” sign indicates that some non-essential information might be lost in the translation to Ψ basis. 5 might be unknown or different from the basis in which the camera is operating. Examples of such basis are the basis formed by pixel coordinates, Fourier basis, wavelets, Hadamard basis and the like.

More exotic forms of sparsity for the image model also exist, including for example sparsity of the norm of the gradient, structured sparsity (mixed norms, group sparsity . . . ). The skilled man could adapt the present invention to take advantage of these sparse image models.

Compressed sensing starts with taking a weighted linear combination of samples A={α₁, . . . , α_{M}} called compressive measurements in a basis Φ={φ₁, . . . , φ_{N}} different from the basis Ψ in which the signal is sparse. Coefficients αᵢ are thus projection of the signal on the second basis Φ: αᵢ= [symbol] x,φᵢ^{T} [symbol] where φᵢ^{T} is the transpose φᵢ. If we write Φ_{M}={φₙ_{₁}, . . . , φₙ_{_{M}}} and C the vector having cₙ_{₁} coefficients as elements, we thus get

$$A = {Φ}_{M}^{T} x \approx \underbrace{{Φ}_{M}^{T} Ψ}_{P} C$$

It was shown by David Donoho, Emmanuel Candès, Justin

Romberg and Terence Tao that the number M of these compressive measurements can be small M<N and still contain nearly all the useful information. When the basis Φ and Ψ are incoherent, meaning that the basis Φ cannot sparsely represent the elements of Ψ, and the number of measurements M is large enough, the image can be recovered using a set A which size M is similar to the size of c. Formally, M has to be at least equal to Klot(N/K), and therefore sparse signals (with sparsity K<<N) can be acquired with a number of measurements much smaller than N, N being the number of samples typically acquired in standard Shannon-Nyquist regular sampling schemes.

The task of converting the image back into the intended domain then involves solving an underdetermined matrix equation B=PC to determine C. The matrix is underdetermined since the number of compressive measurements M taken is smaller than the number of pixels N in the full image. However, adding the constraint that the signal x is sparse enables one to solve this underdetermined system of linear equations and retrieve C from B=PC.

Several algorithms can be used to perform this reconstruction, one of them is called “Basis Pursuit” (see Chen, S., Donoho, D., Saunders, M., “Atomic decomposition by basis pursuit,” SIAM J. on Sci. Comp. 20 (1998) 33-61) and can be solved with traditional linear programming techniques whose computational complexities are polynomial in N. Another examples are “iterative Orthogonal Matching Pursuit” (OMP) (see Tropp, J., Gilbert, A. C., “Signal recovery from partial information via orthogonal matching pursuit,” (2005) Preprint), “matching pursuit” (MP)(see Mallat, S. and Zhang, Z., “Matching Pursuit with Time Frequency Dictionaries”, (1993) IEEE Trans. Signal Processing 41(12): 3397-3415), “tree matching pursuit” (TMP) (see Duarte, M. F., Wakin, M. B., Baraniuk, R. G., “Fast reconstruction of piecewise smooth signals from random projections,” Proc. SPARS05, Rennes, France (2005)), “group testing” (see Cormode, G., Muthukrishnan, S., “Towards an algorithmic theory of compressed sensing,” DIMACS Tech. Report 2005-40 (2005)), “Sudocodes” (see U.S. Provisional Application Ser. No. 60/759,394 entitled “Sudocodes: Efficient Compressive Sampling Algorithms for Sparse Signals,” and filed on Jan. 16, 2006), or statistical techniques such as “Belief Propagation” (see Pearl, J., “Fusion, propagation, and structuring in belief networks”, (1986) Artificial Intelligence, 29(3): 241-288), “LASSO” (see Tibshirani, R., “Regression shrinkage and selection via the lasso”, (1996) J. Royal. Statist. Soc B., 58(1): 267-288), “LARS” (see Efron, B., Hastie, T., Johnstone, I., Tibshirani, R., “Least Angle Regression”, (2004) Ann. Statist. 32(2): 407-499), “Basis Pursuit with Denoising” (see Chen, X., Donoho, D., Saunders, M., “Atomic Decomposition by Basis Pursuit”, (1999), SIAM Journal on Scientific Computing 20(1): 33-61), “expectation-maximization” (see Dempster, Laird, N., Rubin, D., “Maximum likelihood from incomplete data via the EM algorithm”, (1997) Journal of the Royal Statistical Society, Series B, 39(1): 1-38) , and so on.

These retrieval methods were also shown to perform well on compressible signals that might not exactly be K-sparse but are well approximated by a K-term representation. Such a model is more realistic in practice. These algorithms are robust in the presence of additive noise and typically require M˜eK measurements with an overmeasuring factor e>1 on which constrains can be set. The main problem in implementing a hardware realisation of Compressed Sensing then comes to the problem of measuring a signal in a basis Φ sufficiently incoherent with the basis Ψ in which the signal is sparse. The image being unknown before its estimation, the measurement should be conducted in a basis that has a great probability of being incoherent with the basis in which the signal will be sparse. It was theoretically demonstrated that a Gaussian random basis is an example of an ideal basis, meaning a basis that is, with overwhelming probability, optimally incoherent with every physically possible basis Ψ.

### 2. Multiple Scattering Media

### 2.1. Physical Scattering Media

One embodiment of the present invention is an imaging device able to conduct compressive measurements. This device incorporates a multiple scattering medium able to convert a signal's basis into a basis that has a high probability of being incoherent with the basis in which said signal is sparse.

Multiple scattering media are based upon the physical process of scattering. Scattering is a process in which radiations that compose a signal and travel through a medium are forced to elastically deviate from straight trajectories by non-uniformities in the medium. A multiple scattering medium is thus a medium in which the radiations that enter the medium are scattered several times before exiting the medium. Given its sensibility to the precise nature and location of these non-uniformities, it is almost impossible to predict the precise output of such a medium.

Examples of such multiple scattering medium are, for optical radiations, translucent materials, amorphous materials such as paint pigments, amorphous layers deposited on glass, scattering impurities embedded in transparent matrices, nano-patterned materials, and for acoustic radiation, polymers and biological materials such as the human skin.

In a preferred embodiment, the multiple scattering medium can present at least two faces which can be for example at the opposite one of the other in order for the incident signal to penetrate into the material trough one face and leave through the other as a scattered signal. This disposition gives an optimum multiple scattering of the incident signal. The signal can be reflected in various directions while it travels through the medium and the scattered signal can thus be less intense than the incident signal.

In a preferred embodiment, the multiple scattering medium is a linear medium, meaning that non-linear effects acting on the radiation during its path through the medium, like for instance a doubling or a change in the frequency of said radiation, are negligible.

An example of such a multiple scattering medium is a layer of an amorphous material such as a layer of Zinc-oxide (ZnO) on a substrate.

### 2.2. Transmission Matrix of Multiple Scattering Media

A evaluation scheme embodiment able to determine the transmission matrix T of a scattering medium is described.

The transmission matrix T is the matrix that relates the incoming modes Eⁱⁿ with the outgoing modes E^{out}:

$${E}_{m}^{out} = {\sum }_{n} {T}_{mn} {E}_{n}^{in}$$

Measuring the transmission matrix of optical radiations going thru a medium raises several difficulties coming from the impossibility to have access to the amplitude and phase of the optical field. These difficulties where overcome in recent developments (See Popoff, S. M., Lerosey, G., Carminati, R., Fink, M., Boccara, A. C., Gigan, S., “Measuring the Transmission Matrix in Optics: An Approach to the Study and Control of Light Propagation in Disordered Media”, (2010) Phys. Rev. Lett. 104, 100601 (2010)).

The transmission matrix can be retrieved as follow. Using a known wavefront and a full field “four phase method”, one can have access to the complex optic field using interferences. If we inject the n^{th} input mode and measure the intensity at four different global phases: Iₘ⁰, Iₘ^{π/2}, Iₘ^{π} and Iₘ^{3π/2}, the following relation holds:

$$\frac{( {I}_{m}^{0} - {I}_{m}^{π} )}{4} + i \frac{( {I}_{m}^{3 π / 2} - {I}_{m}^{π / 2} )}{4} = {\overline{s}}_{m} {T}_{mn}$$

This relation gives the possibly to measure an observed transmission matrix T_{obs} which is related to the real one T by

T_{obs}=T×S_{ref}

where S_{ref} is a diagonal matrix representing the whole static reference wavefront in amplitude and phase.

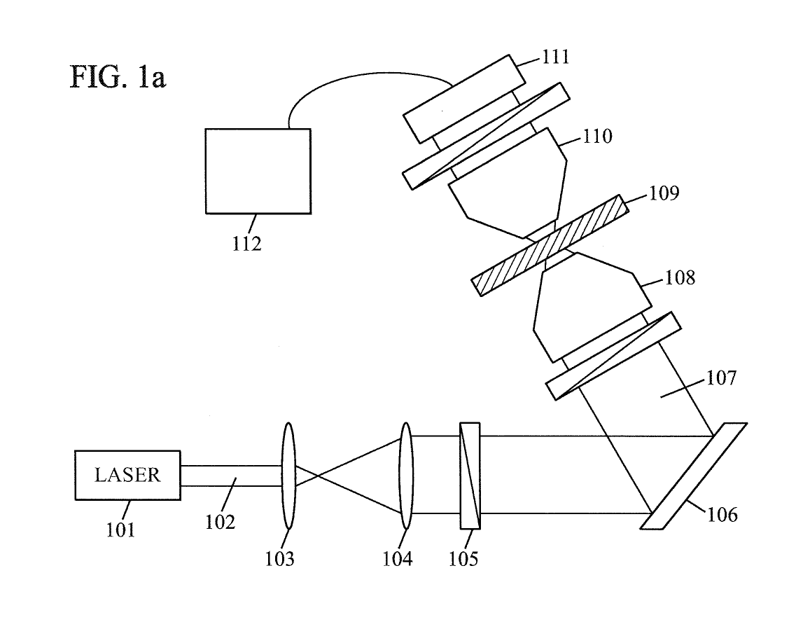

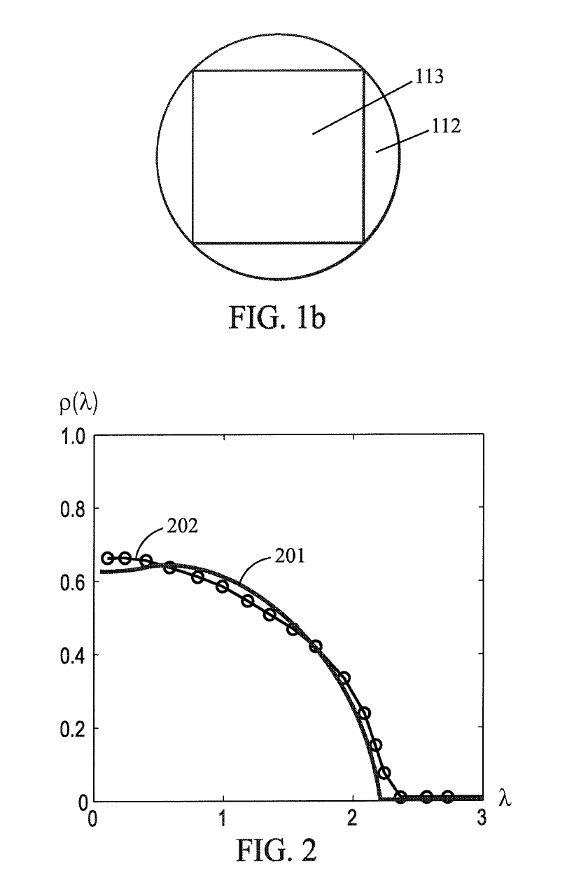

Ideally, the reference wavefront should be a plane wave to directly have access to the T matrix. In this case, all sₘ are constant and T_{obs} is directly proportional to T. However this requires the addition of a reference arm to the setup, and requires interferometric stability. To have the simplest setup and a higher stability, only 65% of the wavefront is modulated as illustrated on FIG. 1b and going into the scattering sample (this corresponds to the square 113 inside the pupil of the microscope objective as seen in FIG. 1b), the speckle coming from the 35% static part 112 being the reference. S_{ref} is then unknown and no longer constant along its diagonal. Nevertheless, since S_{ref} is stationary over time, the response of all input vectors on the m^{th} output pixel can be measured as long as the reference speckle is bright enough on the considered modes and the transmission matrix can thus be evaluated.

Turning now to FIG. 1a, a laser source 101 which consists in a diode pumped solid-state single longitudinal mode laser source at 532 nm, emits a laser beam 102. The laser beam 102 is then expanded using lenses 103, 104 and polarized using a polarizer 105. The laser beam 102 is then spatially modulated using a Spatial Light Modulator 106. This device can for instance be a twisted nematic liquid crystal device on silicon device. Choosing a suitable combination of incident and analysed polarization, an almost phase only modulation can be achieved in a reflected beam 107. The reflected beam 107 is then focused on the multiple scattering medium 109, using an objective 108. The beam is scattered inside the medium 109 and emerge of this medium as a scattered beam which is then refocused by another objective 110 onto a CCD camera 111. The camera 111 can be for instance a 10-bit CCD camera and the objectives 108, 110 are selected such as there is a perfect matching in size between a pixel and a mode, such as the input and output modes of the scattering medium transmission matrix correspond to pixels of the Spatial Light Modulator and the camera respectively. A control unit 112 then retrieves the transmission matrix from the measurements of the camera 111.

FIG. 1c shows an exemplary embodiment of a method to measure the transmission matrix of a multiple scattering medium.

In a first step 150, a series of optical, electromagnetic or acoustic signals or waves is generated using a generator. This generator can be a light source such as a laser or a diode. It can also be an electromagnetic source such as an antenna provided with an active element like an oscillator. It can also be an acoustic source such as a loud speaker, a piezoelectric transducer, a tactile transducer, a transponder or the like.

In a second step 151, a portion of each wave of the series of waves is modulated using a modulator to give a series of modulated waves. This modulator can be a spatial light modulator or an electromagnetic modulator such as a filter, a mirror or any device able to modulate the phase of the signal. The modulator will be adapted to wave frequency and type and will thus be an optical, electromagnetic or acoustic modulator. In the case of acoustics of RF waves, the generator used in step 150 can be the modulator of step 151, as it is the case for an array of antennas or transducers.

In a third step 153, each wave of the series of modulated waves is scattered by the multiple scattering medium, giving a series of scattered waves.

In a forth step 154, the camera measures each scattered wave of the series of scattered waves giving a series of measurements. The camera can comprise detectors of several types depending on the waves to be measured. If the waves are optical waves, the camera can be a Charge-Coupled Devices (CCD) camera or comprise photomultipliers, photodiodes or any optical detector. In the case of acoustic waves, the camera can comprise microphones, tactile transducers, piezoelectric crystals, geophones, hydrophones sonar transponder or any acoustic detectors of the like. If the waves are electromagnetic waves, the camera can comprise antennas, photodetectors, photodiodes, photoresistors, bolometers or any other detector suitable to measure signal in the frequency range of the scattered waves. In some embodiment, the camera will measure the intensity of the wave, in another embodiment, it can measure the amplitude, the series of measurements can thus be a series of intensity measurements or a series of amplitude measurements.

In a fifth step 154, a control unit determines the transmission matrix from the series of measurements and stores it into a memory of the control unit. If the series of measurements is a series of measurements of intensity, the step of determining 154 can include a prior step consisting in determining a series of amplitudes from the measurements of intensity. This prior step can for instance comprise the full field “four phase method” described above.

Eventually, it is possible to determine the transmission matrix in an iterative process. The above described method to measure the transmission matrix of a multiple scattering medium will thus be executed several times in order, for instance to reach a reasonable accuracy of the determined matrix or to correct for variation in the physical properties of the multiple scattering medium that can occur over time.

Several experiments of focusing and detection through a multiple scattering medium give clear evidence that the measured matrix is in fact physical, i.e. effectively links the input optic field to the output ones (See Popoff, S. M., Lerosey, G., Carminati, R., Fink, M., Boccara, A. C., Gigan, S., “Measuring the Transmission Matrix in Optics: An Approach to the Study and Control of Light Propagation in Disordered Media”, Phys. Rev. Lett. 104, 100601 (2010)).

However, this reference method is just one example of amplitude measurement on the detector, here for optical waves. It can be replaced by other methods such as holographic techniques. It is simply not needed in the case where amplitude detectors exist such as in acoustics.

### 2.3. Multiple Scattering Media as Random Basis Converters

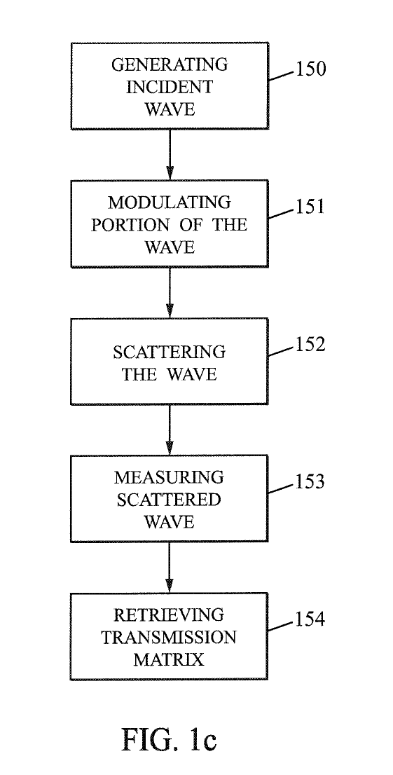

FIG. 2 shows a singular value decomposition of the transmission matrix of a multiple scattering medium. A theoretical result of Random Matrix Theory predict that the statistical distribution ρ(\tilde{λ}) of the singular values of random matrix follows the so-called “quarter circle law” 201 where \tilde{λ} are the singular values normalized by the total intensity.

Indeed, it can be seen on FIG. 2 that the singular values 202 of the transmission matrix of multiple scattering media follow very closely the prediction for a random matrix.

A consequence of that is that a multiple scattering medium can be considered as projecting incoming modes Eⁱⁿ onto a random basis. While this random basis have all the statistical properties of a random set it is still deterministic: identical incoming modes Eⁱⁿ will lead to identical outgoing modes E^{out}.

Each realisation of a multiple scattering medium is a projector onto a specific random basis and can be characterized entirely by its transmission matrix.

3. Compressed Sensing with a Multiple Scattering Medium

In the Compressed Sensing theory, random basis have advantageous characteristics as they were shown to be incoherent, with high probability, with any arbitrary fixed basis. The statistical randomness of multiple scattering medium thus implies that this medium can convert any basis in a random basis that will in turn have a high probability of being incoherent with the arbitrary basis in which the signal is represented by a sparse matrix. It should be noted that amongst all distributions for entries of the random measurement matrices, a Gaussian probability density function has the best behaviour for signal recovery.

Provided that the signal basis was converted to this pseudorandom basis, CS theory tells us that a small number of measurements would then contain the majority of the useful information.

One embodiment of the present invention thus relates to a method for estimating an optical, electromagnetic or acoustic image comprising several steps.

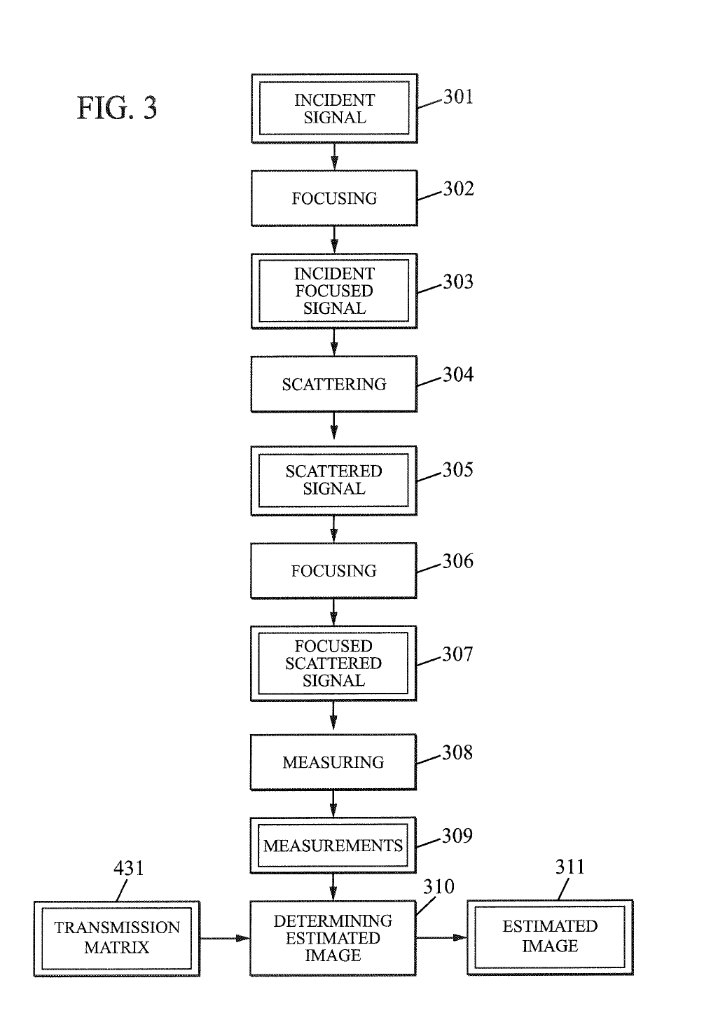

FIG. 3 shows the steps according to a first embodiment. During a first step 302, the incident signal 301 is focused into an incident focused signal 303 onto a multiple scattering medium. The incident signal 301 and incident focused signal 303 can be acoustic signals, electromagnetic signals or optical signals.

In a second step 304, the incident focused signal 303 is then scattered by the multiple scattering medium 430 in a scattered signal 305. The multiple scattering medium 430 is adapted to efficiently scatter the signal used in the embodiment of the invention. It would thus be an acoustic, electromagnetic or optical scattering medium if the signal is respectively acoustic, electromagnetic or optical. The multiple scattering medium 430 is characterized by its transmission matrix 431 which is stored into a memory 461 of a control unit 460.

In a third step 306 the scattered signal 305 is focused, in a scattered focused signal 307, onto a detector array 450.

In the following forth step 308, the scattered focused signal 307 is measured by the detector array 450 giving a set of measurements 308 which are transmitted to the control unit 460. These measurements 308 can be stored in a memory 461 of the control unit 460.

In a step 310, a processor 462 of the control unit 460 uses the set of measurement 308 and the transmission matrix 431 stored in the memory 461 to determine an estimated image 311 comprising a set of image elements 312.

Processor 462 determines an estimated image 311 using one of the previously described algorithms. Following CS theory, the estimated image 311 will thus comprise a number of image elements 312 that is greater than the number of measurements 308.

It is to be noted that image elements 312 are defined by the fact that each image element 312 brings relevant information to the estimated image 311. We use the term “image element” in a different sense than the usual meaning of the term “pixel”.

Indeed, “pixels” are not always bringing information to an image. For example, an “upsampling” algorithm can be used to increase the number of pixels of an image but it will not add any new information to said image. The number of “image elements” of said image after the application of the “upsampling” algorithm is identical to the number of “image elements” before the application of the algorithm.

In other words, dividing every pixel of an image in, for instance, four pixels increases the number of pixels of said image but does not increase the amount of information contained in said image and thus does not increase the number of “image elements”.

The number of image elements is identical in some embodiment with the number of pixel “at full resolution”.

An estimation of an image according to the present invention is thus estimated with fewer measurements than image elements, at full spatial bandwidth.

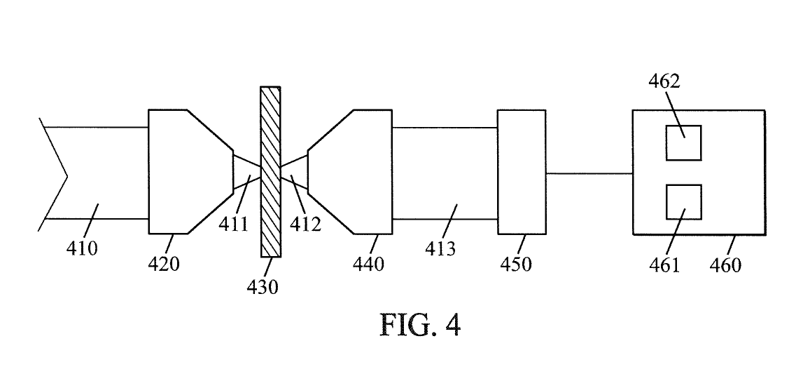

A hardware realisation of the present invention is illustrated on FIG. 4. The optical, acoustic or electromagnetic signal 410 to be acquired runs through an objective 420 to be focused in an incident focused signal 411. This focused signal 411 goes through a multiple scattering medium 430 in which it is scattered in a scattered signal 412. The scattered signal 412 is then focused again in a focused scattered signal 413 by using an objective 440. Eventually focused scattered signal 413 is measured by a camera 450 giving a set of measurements that are transmitted to a control unit 460.

This control unit 460 can comprise a memory 461 able to store a transmission matrix 431 associated with the scattering medium 430 as well as the set of measurements. It can also comprise a processing unit 462 able to determine an estimated image from the transmission matrix and the set of measurements. The camera 450 is a transducer adapted to the signal. If the signal is an optical signal, it can be a Charge-Coupled Devices (CCD) camera or comprise photomultipliers, photodiodes or any optical detector. In the case of an acoustic signal, the camera 450 can comprise microphones, tactile transducers, piezoelectric crystals, geophones, hydrophones sonar transponder or any acoustic detectors of the like. If the signal is an electromagnetic signal, the camera 450 can comprise antennas, photodetectors, photodiodes, photoresistors, bolometers or any other detector suitable to measure a signal in the frequency range of interest.

The objectives 420 and 440 can be adapted by the skilled man and comprise optics such as polarizers, lenses, filters, mirrors, optical fibers or any other optical device.

1. A method for estimating an optical, electromagnetic or acoustic image comprising an imaging operation having at least the successive steps of:
scattering an incident signal into a scattered signal using a multiple scattering medium characterized by a transmission matrix stored into a memory of an imaging system;
measuring the scattered signal using a detector array to provide measurements and storing said measurements into the memory of the imaging system; and
determining an estimated image comprising a set of image elements from said measurements and said transmission matrix, by means of a processor of said imaging system.

2. The method according to claim 1 wherein the estimated image has a number of image elements that is greater than the number of measurements, at full spatial bandwidth.

3. The method according to claim 1, wherein the step of scattering is accomplished by making the incident signal penetrate into the multiple scattering medium.

4. The method according to anyone of claim 1, wherein the step of determining an estimated image from the measurements uses a sparsity-promoting algorithm.

5. A The method according to claim 1, comprising a characterization operation before the imaging operation, said characterization operation comprising at least successive the steps of:
generating a series of incident waves;
modulating at least some portion of the wavefront of the series of incident waves by a series of patterns using a modulator to provide a series of modulated waves;
scattering the series of modulated waves into a series of scattered waves using the multiple scattering medium;
measuring the series of scattered waves using a detector array to provide a series of measurements;
determining the transmission matrix of the multiple scattering medium from the series of measurements, by means of a processor of the imaging system; and
storing said transmission matrix in a memory of the imaging system.

6. A method for measuring the transmission matrix of a multiple scattering medium comprising the steps of:
generating a series of waves;
modulating at least some portion of the wavefront of the series of incident waves by a series of patterns using a modulator to provide a series of modulated waves;
scattering the series of modulated waves using the multiple scattering medium to provide a series of scattered waves;
measuring the series of scattered waves using a detector array to provide a series of measurements; and
determining the transmission matrix of the multiple scattering medium from the series of measurements, by means of a processor;

7. An imaging system for estimating an optical, electromagnetic or acoustic image comprising:
a multiple scattering medium that scatters an incident signal into a scattered signal;
a detector array that measures said scattered signal to provide measurements;
a memory that stores a transmission matrix characterizing the multiple scattering medium and said measurements; and
a processor that determines an estimated image comprising a set of image elements from said measurements and said transmission matrix.

8. The imaging system according to claim 7, further comprising lenses to focus the incident signal onto the multiple scattering medium and onto the detector array.

9. The imaging system according to claim 7, wherein the estimated image has a number of image elements that is greater than the number of measurements.

10. The imaging system according to claim 7, wherein the incident signal penetrates into the multiple scattering medium.

11. The imaging system according to claim 7, wherein the multiple scattering medium is an object having at least two faces and is arranged in the imaging system so that the incident signal enters the multiple scattering medium through one face and leaves through another face.

12. The imaging system according to claim 7, wherein the multiple scattering medium is a diffusive material.

13. The imaging system according to claim 7, wherein the multiple scattering medium is an amorphous material.
